(19) United States
(12) Patent Application Publication
(10) Pub. No.: US 2009/0327895 A1
(43) Pub. Date: Dec. 31, 2009

(54) Streaming Distribution of Multimedia Digital Documents Via a Telecommnnication Network

(76) Inventors: Sandrine Bailloux, Noyers-Bocage (FR); Jacques-Olivier Rebillon, Mutrecy (FR); Olivier Normand, Fontaine Henry (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/992,974

(22) PCT Filed: Sep. 27, 2006
(86) PCT No.: PCT/FR2006/050951

§ 371 Date: Sep. 15, 2009

(30) Foreign Application Priority Data
Sep. 30, 2005 (FR) 0552982

(51) Int. Cl. G06F 15/16; G06F 3/01

(52) U.S. Cl. 715/730; 709/231

(57) ABSTRACT

A system for supplying digital multimedia documents via a telecommunications network. The system includes document server means (10) adapted to stream digital multimedia documents to user terminals (30) connected to the network (20) and each comprising a playback interface (32) adapted to play digital multimedia documents in real time. The document server means (10) include a multimedia content server (11) containing digital multimedia documents each associated with a playback index having values that identify predetermined portions of the document, index determination means (12) for determining at a given time during transmission of any document from the content server to a user terminal the current playback index value corresponding to the portion of the document being transmitted at that time, and transmission initiating means (12) for initiating transmission of any document from the content server to a user terminal starting from a portion of said document identified by a playback index value determined beforehand by said index determination means.

The field of the invention is that of remotely accessing and consulting via a telecommunications network multimedia contents made available by broadcast servers.

The invention relates in particular to the field of audio books in the form of digital files listened to by users on their listening terminals. Nevertheless, the invention applies to any type of digital audio file having content that corresponds to a spoken, sung, or musical work, for example.

To be more precise, the invention relates to a system for supplying multimedia digital documents via a telecommunications network including document server means adapted to supply such documents in streaming mode to user terminals connected to the network.

In the context of the present invention, “streaming” refers to broadcasting multimedia contents, usually in compressed form, and playing them in real time on the destination terminal without downloading them, i.e. playing them at the same time as the terminal receives them.

Moreover, in the context of the invention, spoken works can correspond to audio versions of books, newspapers, magazine articles, radio broadcasts, plays, specialist magazines, technical manuals such as instructions for assembling an item delivered in the form of a kit, gardening magazines, recipes, general or specialist dictionaries, help tools in document form, etc. Such works are stored in a digital format, either directly by their author or by an interpreter, and played in a digital format; or they can be synthesized by means of dedicated technologies, such as the Text To Speech technology.

For example, the invention also applies to digital files containing recordings of musical concerts with a commentary or radio broadcasts offering spoken, sung, and musical contents.

Telecommunications networks such as the Internet currently provide services for downloading digital documents containing stored texts (books, articles, etc.). To benefit from this kind of service, the user must typically first subscribe to a merchant's Internet site, the subscription usually entailing a payment.

Thus in the conventional way a user wishing to listen to a chosen audio book is first connected to an Internet site supplying digital audio contents, for example by means of a personal computer (PC) or a personal digital assistant (PDA); the user is then identified by the site so that his access and downloading rights can be verified for consistency with his subscription or, if he has no subscription, after confirmation of his order and/or payment for his order. Once identified/authenticated by the Internet site, the user can then access a list of audio documents—for example, newspapers, radio broadcasts—that he can select and download to his terminal via his network connection.

The company Audible Inc., well known in the field of supplying audio books, now offers its customers an online subscription service for downloading all types of spoken audio content.

The Audible Inc. offer is therefore based on payment to download digital files corresponding to audio documents required by the user, who is connected to the company's website, for example by means of a low bit rate (dial-up) connection or an ADSL connection.

Once digital audio files have been downloaded in a format selected beforehand by users, they can be written to a digital compact disk (CD-ROM) or loaded into a player compatible with the digital format of the downloaded files, for example an MP3 or MP4 player, or listened to directly using a hardware and/or software player.

A major drawback of the solutions currently offered by audible content providers such as Audible Inc. is linked to the fact that they impose complete downloading of a large volume of digital data, which takes a long time and occupies considerable memory space in the terminal that has to store the downloaded files.

To illustrate this drawback, an audio book comprising 300 pages in paperback format, for example, represents around seven CD-ROMs or about eight hours of listening in a non-compressed format and 700 megabytes of memory in the MP3 compressed format. Moreover, it represents around seventy hours of downloading via a low bit rate 56 kbps (kilobits per second) Internet connection.

Moreover, the above downloading constraints (duration, memory space) are incompatible with the use of “light” terminals, since they have only a limited memory capacity, or with use when on the move, by means of a mobile telecommunication terminal, such as a cellular telephone connected to a GPRS, UMTS or other type of telecommunications network.

Another drawback of the current solutions relates to browsing a downloaded audio book. Once a document has been downloaded and stored on the hard disk or in the memory of the user terminal, for example a PC, the tools for playing it allow only continuous play, which causes problems with resuming playback later from the place in the document where it was previously interrupted. The user is therefore obliged, before he can resume listening at the place where listening was interrupted, to determine the approximate location of the interruption of the document concerned, for example by using his player in a fast forward mode or by moving a graphical cursor to advance playback to an estimated point on a graphical interface representative of the length of time for the document has been played.

An encoding and browsing standard known as DAISY (Digital Accessible Information SYstem) has been created to improve browsing a previously downloaded digital audio document. DAISY is a recording standard for digital audio files, and can be applied to digital audio books.

The DAISY standard was originally designed to enhance user friendliness for persons with vision problems by facilitating access to digital audio files and simplifying browsing by audio means. To this end, DAISY proposes a dedicated player implementing the standard. In particular, DAISY enables browsing in accordance with concepts specific to books: browsing from page to page, paragraph to paragraph, chapter to chapter, sentence to sentence, just like handling a book in paper format.

However, although digital audio files in the DAISY format are compatible with browsing functions that are more user friendly, and particularly well adapted to the expectations of an audio book user, they have the drawback of requiring even more storage capacity than an audio book of more conventional format (for example the MP3 format). For this reason, digital audio documents in the DAISY format are usually sold in the CD-ROM or DVD-ROM format. Such documents are therefore incompatible with downloading from an audio book supplier and/or with storage on a light customer terminal.

A particular aim of the present invention is to alleviate the above drawbacks of the prior art. Consequently, one objective of the invention is to provide a technical solution enabling users to listen to and to interact with multimedia contents such audio books without previously downloading the corresponding digital files, partially or completely, and without requiring a high storage capacity in the customer terminal used.

Another objective of the invention is to offer a solution of the above kind that enables access, when on the move, to text contents in audio form made available by a supplier of works to be listened to, for example by means of a mobile terminal offering network access, even at a low bit rate.

An additional objective of the invention is to provide a technical solution of this kind that facilitates interaction with the content of digital audio files corresponding to multimedia works to be listened to.

A further objective of the invention is to provide a technical solution of this kind that enables users to resume listening to any audio work exactly where playback was previously interrupted, whether intentionally or unintentionally.

A further objective of the invention is to provide a technical solution of this kind that enables users to stop listening to digital audio files and to resume listening afterwards with the benefit of functions for browsing within the digital file, emulating those usually employed by users when using paper documents (fast forward and rewind by sentence, paragraph, chapter, etc.).

An additional objective of the invention is to offer a technique of this kind that can be used from any type of terminal, locally or remotely, with the same ergonomic features and the same quality of service, as well as enabling listening to be started on a first terminal and continued from a previously-defined interruption point on another terminal, regardless of the telecommunications network used.

In other words, an overall objective of the invention is to provide a technical solution for accessing, listening to and manipulating digital sound files while receiving them in streaming mode that is independent of the listening terminal and the network connection used.

To meet the objectives stated above, a first aspect of the present invention consists in a system for supplying digital multimedia documents via a telecommunications network, including document server means adapted to stream digital multimedia documents to user terminals connected to the network and each comprising a playback interface adapted to play digital multimedia documents in real time. According to the invention, this system is noteworthy in that the document server means include:

a multimedia content server containing digital multimedia documents each associated with a playback index having values that identify predetermined portions of the document;

index determination means for determining at a given time during transmission of any document from the content server to a user terminal the current playback index value corresponding to the portion of the document being transmitted at that time; and

transmission initiating means for initiating transmission of a document from the content server to a user terminal starting from a portion of said document identified by a playback index value determined beforehand by said index determination means.

For example, sending a document to a user terminal could be started from an index stored previously, at the time of interrupting previous transmission of the document to the same terminal. This index value, which in this example may be defined as meaning “resume transmission”, then corresponds to the portion of the document that was being transmitted at the time of the interruption. Such interruption of transmission can occur in the event of intentional interruption of playback by the user of the terminal in question, for example, or after the network connection between the terminal and the content server is cut off.

The invention can be applied to any type of multimedia, audio and/or image digital content, for example, that can be consulted in streaming mode. In particular, the invention proves particularly pertinent in the context of consulting text contents in audio form, such as digital audio books, in streaming mode.

According to a preferred feature of the invention, the server means further include a user database containing user information for each user including a list of the references of all documents for which the user concerned has playback rights and for each document reference from the list, at least one playback index value corresponding to the portion of the document that was being transmitted at the time of the latest interruption of playback of the document for the user concerned, the transmission initiating means being adapted to initiate transmission of a document from the content server to a user terminal, starting from a portion of the document identified by a playback index value stored in the user database for the user and the document concerned.

Such interruption of playback can be caused by an intentional action of the user on a customer terminal aiming to interrupt playback of the text content in audio form. This may entail pressing a key on the user terminal, for example, or using a function of the playback interface of the terminal such as generating an electronic bookmark. Such interruption can also be outside the control of the user, for example in the event of a network failure or a hardware or software fault in the user terminal.

In one embodiment of the invention, the server means include means for periodically updating the index value associated with a document from the content server at time intervals during transmission of the document to a user terminal. In this way, in the event of interruption of transmission of a document by the server means or interruption of playback of a document by a user terminal, the latest playback index value stored in the user database for the user and the document concerned before the interruption can be used on subsequent retransmission of the document starting with the portion of the document identified by that index value.

According to an advantageous feature of the invention, the playback index value associated with a document from the content server includes browsing data describing the organization of the content of the document into a predefined set of sub-portions, the playback interface of each user terminal comprising:

means for processing and presenting to the user the browsing data associated with a given document from the content server; and

means for generating a request to play a document sent to the document server means and including the reference of a document to be played and where appropriate further including browsing options information determined from browsing data associated with the document, the browsing options information indicating a sub-portion of the document chosen by the user of the terminal concerned and from which playback of the document must be initiated.

According to one particular feature, the browsing options information contained in a playback request includes the value of the playback index of the document corresponding to the chosen sub-portion of the document, this index value being determined by the playback interface of the terminal concerned from the browsing data of the document.

In one embodiment, the index determination means in the document server means are adapted to determine from the browsing options information contained in a document playback request the value of the playback index of the document that corresponds to the chosen sub-portion of the document.

In another embodiment of the invention, in which a user terminal is a voice access telephone terminal connected to a telephone network, the system further comprises:

a voice server that constitutes the playback interface of the user terminal and is accessible via the telephone network; and

an adaptation server that provides the interconnection between the voice server and an Internet-type network to which the multimedia document server means are connected, for adapting exchanges in accordance with the respective communication protocols used between the voice server in the telephone network and the document server means in the Internet-type network.

The system of the invention for supplying documents briefly explained above can advantageously be applied to supplying digital audio books whose content is organized as a set of sub-portions of the type defined by the organization characteristic of the content of a paper book.

A second aspect of the invention consists in a user terminal connectable to a telecommunications network, noteworthy in that it includes a playback interface adapted to the use of the terminal in a document supply system as briefly defined above. According to the invention, the interface comprises:

means for processing and presenting to the user browsing data associated with a given document from the content server; and

means for generating a request to play a document sent to the document server means and including the reference of a document to be played, and where appropriate further including browsing options information determined from browsing data associated with the document, the options information indicating a sub-portion of the document chosen by the user of the terminal concerned from which playback of the document must be initiated.

In a preferred embodiment, this playback interface takes the form of a data processing program resident in the user terminal or downloadable via the telecommunications network from digital multimedia document server means during connection of the terminal to the server means, for example by means of Internet browser-type software. Consequently, the present invention also consists in a playback interface computer program of this kind.

A third aspect of the present invention consists in a method of playback on a user terminal of a multimedia digital document supplied by a digital multimedia document supply system of the invention, as briefly described above, the method being noteworthy in that it includes the following steps:

selecting a document to play on the user terminal;

obtaining browsing data associated with the selected document;

selecting a sub-portion of the document as a function of the browsing data and generating browsing options information representing the selected sub-portion;

creating a playback request including the reference of the document selected for playback and the browsing options information and sending the request to the document server means via the network; and

receiving and simultaneously playing the selected document starting from the sub-portion of the document determined by the document server means from the browsing options information.

The advantages associated with the above terminal and the above playback method are identical to those briefly explained above relating to the system of the invention for supplying documents.

Other features and advantages of the present invention become more clearly apparent on reading the following description of preferred embodiments of the invention, provided by way of non-limiting example, with reference to the corresponding appended drawings, in which:

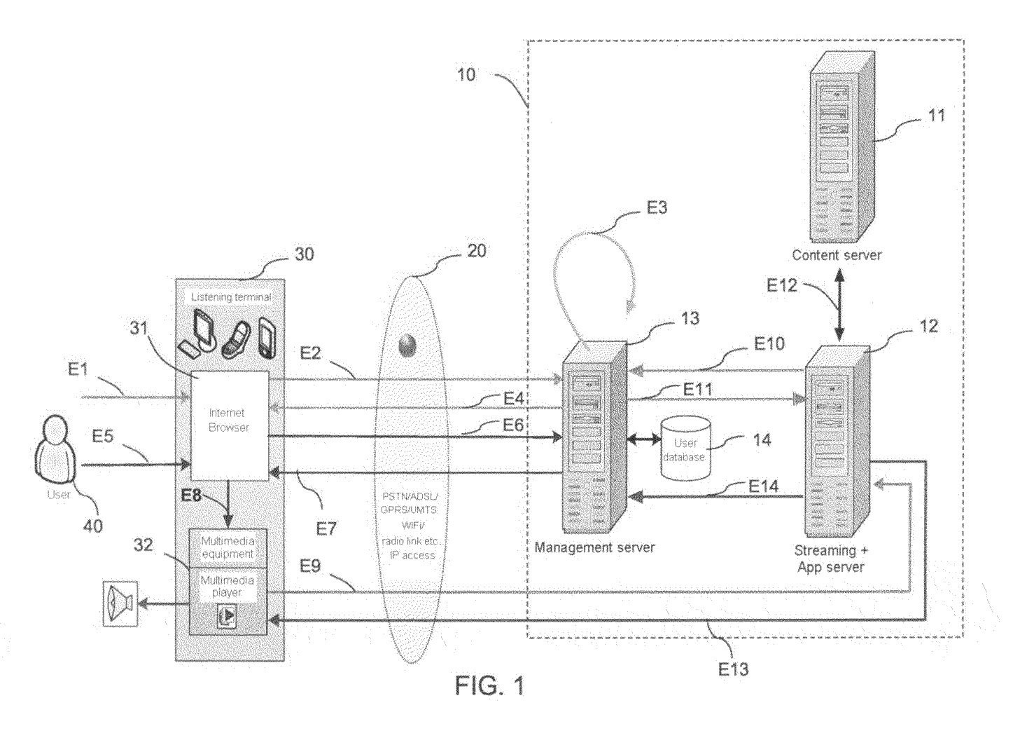

FIG. 1 shows the architecture of a first embodiment of the system of the invention for supplying digital multimedia documents, in which the user terminals are IP terminals connected to an Internet-type network, and the general process for playback of a multimedia content by an IP terminal in that architecture;

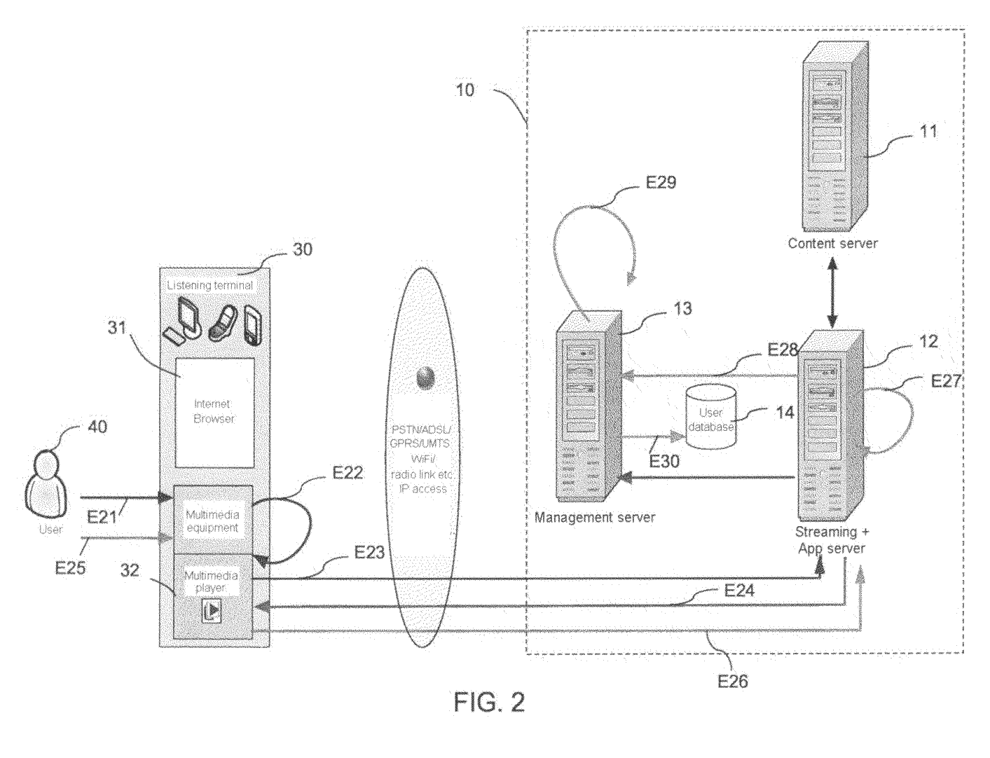

FIG. 2 shows one example of the process of interaction in the first embodiment of the system for supplying documents between the user of an IP terminal and a multimedia content they have obtained;

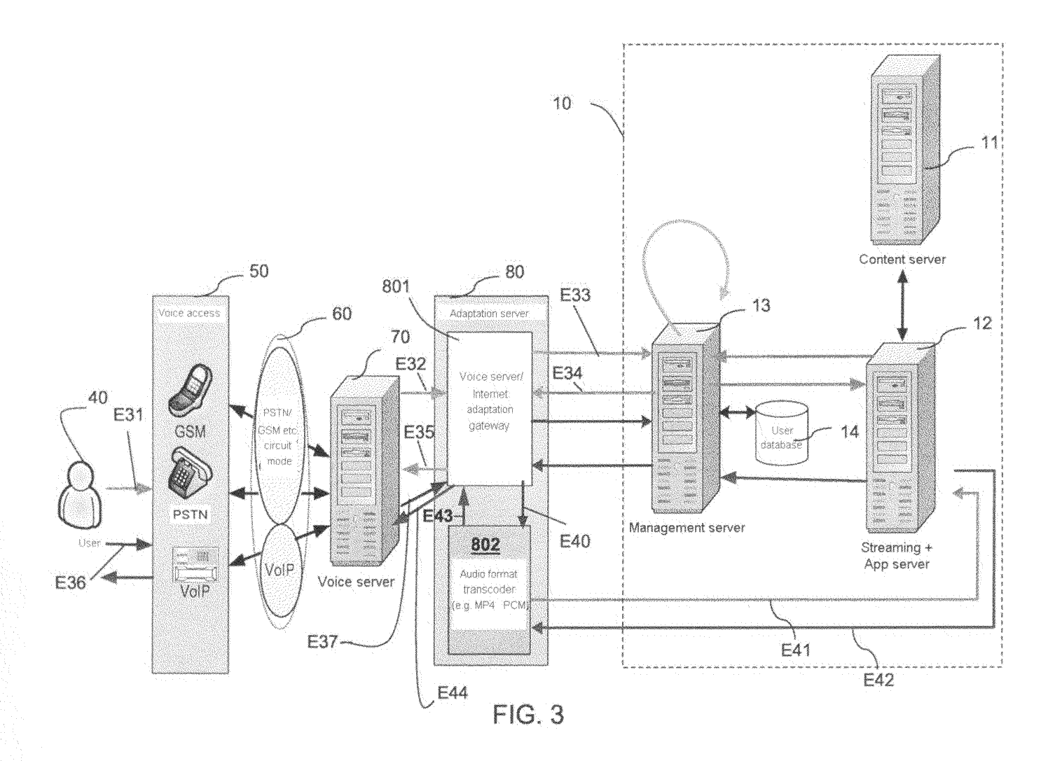

FIG. 3 shows the architecture of a second embodiment of the system of the invention for supplying documents, in which the user terminals are voice access type terminals, and the general process for playback of a multimedia content by that kind of a voice access terminal in that architecture; and

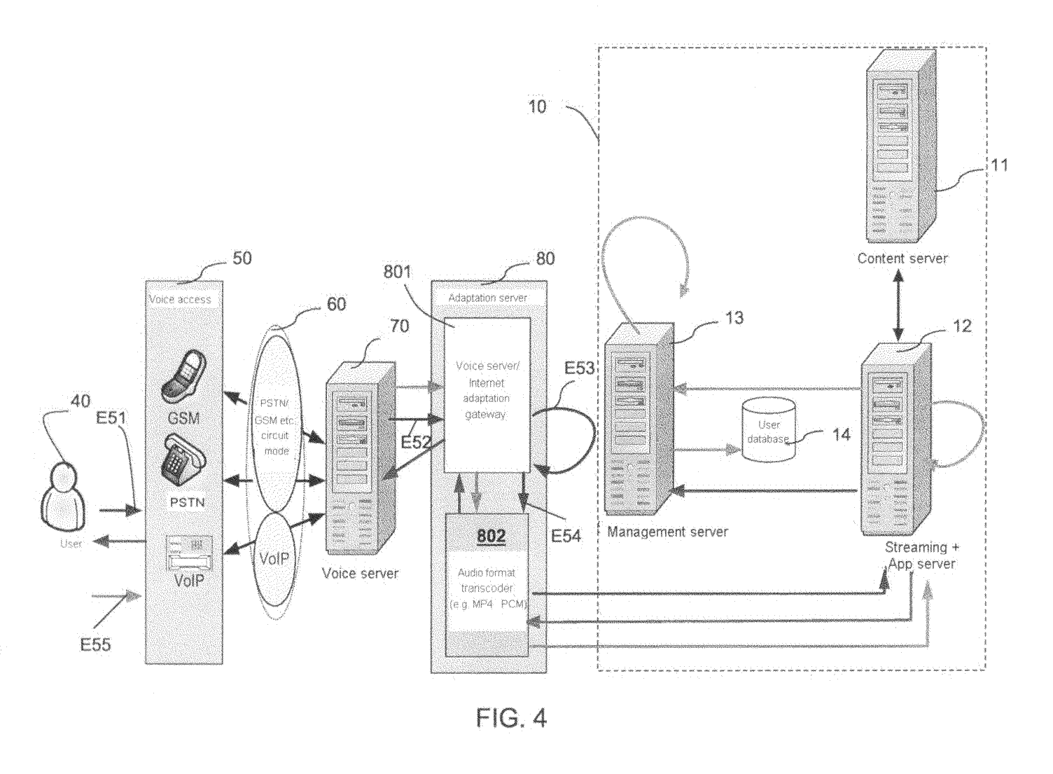

FIG. 4 shows one example of the process of interaction in the second embodiment of the system for supplying documents between the user of a voice access terminal and a multimedia content that they have obtained.

A first embodiment of a system of the invention for supplying digital multimedia documents, in which system the telecommunications network is an Internet-type network and the user terminals are IP (Internet Protocol) terminals, is described next with reference to FIGS. 1 and 2.

As shown in FIG. 1, the system of the invention for supplying multimedia documents includes a document server 10 providing access to multimedia documents in a streaming-type transmission mode via a telecommunications network 20 and via user terminals 30 connected to the network.

In this example the network 20 is an Internet-type network or an Internet access network, for example a GSM or UMTS network, connected to the Internet-type network.

The user terminals 30 are connected to the network 20 by standard connecting means as a function of the nature of the user terminal concerned.

In the example shown in FIG. 1, the user terminals considered are IP terminals, i.e. terminals that can be connected to the Internet-type network directly or via an Internet access network or equipment. Thus an IP (Internet Protocol) user terminal can be a personal computer fitted with a dial-up or ADSL modem or connected to a home gateway connected to the Internet, a GPRS or UMTS telephone terminal or a personal digital assistant (PDA) connected to a WiFi access point.

Each user terminal 30 includes an interface (31, 32) for streaming multimedia documents obtained via the network 20. In the example represented in FIGS. 1 and 2, this interface is a standard Internet browser 31 associated with a software application 32 constituting the playback interface as such and adapted to stream digital multimedia documents from the document server 10.

In the chosen embodiments shown in the appended drawings, the document server 10 consists of three sub-systems:

A management server 13, which in particular manages customer accounts, user customer playback sessions, and a user database 14 of which contents are explained below. The management server also verifies user access and playback rights (authentication).

A digital multimedia content server 11 storing documents offered for distribution, each document possibly consisting of multiple files.

A streaming mode transmission server (streaming server) 12 handling transmission, upon request, of documents stored in the content server 11 in accordance with communication protocols that support streaming.

Of course, the servers 11, 12, and 13 in the network can be physically combined in a single server machine.

According to the invention, each of the multimedia documents stored in the content server 11 is associated with a playback index, having values that identify predetermined portions of the document. Here “portion” refers to a particular place in the document concerned or a particular sub-portion or segment of the document within its linear playback dimension (between the start and the end of the document).

In one particular embodiment, the playback index associated with each document is or includes a time index, i.e. an index whose values measure the transmission time that has elapsed since the start of the document concerned. An index value then corresponds to a numerical value expressed in predefined time units, for example milliseconds (ms). For example, the playback index of a digital audio book with a playback time of one hour could consist of 3,600,001 values from 0 ms (the start of the document) to 3,600,000 ms (the end of the document).

In one particular embodiment of the invention, the playback index of a document is generated “on the fly” in the streaming server, for example when sending the document to a customer terminal.

According to the invention, the playback index associated with any document from the content server includes browsing data describing the organization of the content of the document concerned into a predefined set of sub-portions.

In the field of digital audio books, this browsing data represents the organization of the document as defined by the typical organization of the content of a paper book, i.e. a hierarchical organization of the type: parts, chapters, pages, paragraphs, sentences, words, etc.

In practice, this kind of index can be produced by associating certain values of the playback time index text and/or digital tags indicating the start and/or the end of a predefined sub-portion of the document; for example, the tag ‘1; 52; 3; 5’ could mark the 5^{th} word of the 3^{rd} sentence of the 52^{nd} paragraph of the first chapter of the document.

Note that the playback index can consist only of a tag-type index, with no concept of the time elapsed since playback started.

Referring again to FIG. 1, the management server 13 includes a user database 14. According to the invention, the user database 14 contains, for each user registered as a client of the document broadcast service, user information that includes a list of references of all documents for which the user concerned has playback rights and, for each document reference from that list of references, at least one document playback index value. This stored index value, if it is not null or void, is an index value of the document obtained at the time of a previous interruption of playback of the document by the user. Consequently, this index value identifies the portion of the document that was being transmitted at the time playback was interrupted.

The index values stored for a given user and a given document can also correspond to electronic bookmarks deposited electronically via the user. The nature (bookmark, interruption value, etc.) of an index value stored in the database is specified by specific information or a particular field in the database, for example.

To obtain the aforementioned playback index values, i.e. those stored in the user database 14, the streaming server 12 includes an index determination module, in practice a software module, for determining at a given time during transmission of any document from the content server to a user terminal the value of the playback index corresponding to the portion of the document being transmitted at that time, called the current index value.

To be more precise, the index determination module determines this current index value periodically, i.e. at regular time intervals, during transmission of the document concerned to a user terminal. Each current index value determined in this way is then sent by the streaming server 12 to the management server 13, which then updates a dedicated field of the user database 14 that corresponds to the user and the document concerned with the latest current index value received from the streaming server.

In this way, in the event of intentional or unintentional interruption of playback of a document via a user terminal, the latest playback index value stored in the database 14 for the user and the document concerned can serve as a playback index value for starting transmission of the document on subsequent resumption of playback of the document by that user.

To this end, according to the invention, the streaming server 12 is adapted to initiate transmission to a user terminal of a document obtained beforehand from the contents server 11, starting with a portion of the document determined by a playback index value that is obtained beforehand by the index determination module, from information stored in the user database 14 for the user and the document in question.

As mentioned above, in a preferred embodiment of the invention, the playback index associated with any document in the content server 11 includes browsing data describing the organization of the content of said document into a predefined set of sub-portions.

In one particular embodiment of the invention, the browsing data associated with a particular document is sent with the document itself when that document is being played in the user terminal concerned. This browsing data can also be downloaded when the user 40 selects a document to play from a list of documents during initialization by the user 40 of a playback session by having the Internet browser 31 point to a web page of the Internet site offering the document broadcasting service of the invention.

To be able to use this browsing data, the playback interface (31, 32) of each user terminal 30 includes means for processing and presenting to the user browsing data associated with a given document from the content server. That data is represented graphically on a display screen (not shown in the figures) of the user terminal, for example.

In one embodiment, the playback interface of a user terminal includes browsing functions represented graphically or produced in the form of physical keys and including:

pause playback command;

deposit electronic bookmark command, for resuming playback of the document concerned from the portion of the document marked by the bookmark (a particular value of the playback index);

commands for direct access to sub-portions of the document, such as sentences, paragraphs, chapters or bookmarks already stored for the document concerned;

command for selecting a document in a list of documents available from the online document broadcasting service; etc.

Each command activated by the user is translated into a corresponding request by the playback interface of the terminal concerned and sent to the streaming server 12, which then executes the command in question. For example, if the command is a deposit electronic bookmark command, the value of the playback index associated with the command in the request is sent to the management server 13 in order to be stored in a dedicated user bookmark field of the user database 14 for the user and the document concerned.

According to the invention, the user interface (31, 32) of a user terminal includes means for generating a request to play a document that is sent to document server means and includes the reference of a document to be played and possibly browsing options information. According to the invention, this browsing options information is determined from browsing data associated with the document and indicates a sub-portion of the document chosen by the user of the terminal concerned and from which playback of the document by the streaming server must be initiated. In the context of digital audio books, the chosen sub-portion can be the number of a chapter and the number of a particular paragraph of the chapter, for example.

In practice, the browsing options information contained in a playback request includes the value of the playback index of the document corresponding to the chosen sub-portion of the document. This index value is determined from the browsing data of the document by the playback interface of the terminal concerned.

In a different embodiment, the value of the playback index of the document, which corresponds to the chosen sub-portion of the document, is determined by the streaming server after reception of the playback request, from browsing options information contained in the request.

Still referring to FIG. 1, an embodiment of a method of playing a multimedia content by an IP terminal in the architecture represented in FIG. 1 and described above is described next.

As represented in FIG. 1, in the step E1, the user 40 of the terminal 30 is connected via the web browser 31 to the Internet site (website) hosted by the management server 13. To this end, in the conventional way, he must first enter a user name (login) and a password (authentication) to access the document broadcasting service.

In the step E2, the browser 31 then sends an authentication request to the management server 13 which, on receiving the request, and by consulting the user database 14, effects the necessary verifications concerning the existence of a user account and the associated rights for the identified user.

In the step E3, the management server 13 creates a session associated with this user and with the terminal 30 used, after which, in the step E4, it sends the terminal a response containing data for displaying on the terminal a personal space associated with the user and information relating to multimedia contents for which the user holds playback rights, that information including, where appropriate, the progress of previous playback of the documents (latest playback index value or index value corresponding to an electronic bookmark).

In the step E5, the user 40 consults the list of available documents and the information supplied by his personal space on screen and selects the title of a document by means of a specific action (keyboard, mouse). Then, in the step E6, the web browser 31 sends the management server a playback request having as parameters the title of the chosen document, the parameters of the playback session, and the type of terminal and connection used.

The management server 13 then verifies the playback rights of the user in relation to the title requested and recovers the playback context relating to that document and that user (playback index value, electronic bookmark, etc.), again by consulting the database 14.

In the step E7, the management server then responds to the playback request by sending the terminal 30 a response containing a URL for obtaining the document requested from the streaming server 12. That URL is of the following type:

rtsp://streaming_server_name:port/content_name.mp4/s essionid=my_session/DESCRIBE=listening_start_index.

In this embodiment, when the web browser 31 of the terminal receives this response, a command contained in the response initiates opening (step E8) of a streaming mode data stream multimedia player 32 and execution by the multimedia player 32 of the URL contained in the response received from the management server. Execution of that URL by the player 32 has the effect of sending the streaming server 12 (step E9) a request to stream the document identified in the URL address.

In this example, the multimedia player 32 is a plug-in for the web browser 31, i.e. complementary application software which, associated with a web browser, automatically comes into play in the presence of a multimedia object (here contained in the response E7 from the management server), without the user having to intervene.

The streaming server 12 then receives and processes the request from the multimedia player and in turn sends the management server a request (step E10) to verify again the user's rights concerning the requested document. In response, the management server 13 consults the user database 14 and sends the streaming server 12 (step E11) a response confirming the validity of the user's rights.

In an embodiment in which playback index values stored in the database 14 are not sent to the user terminal 30 in the response sent by the management server in the step E7, those index values are supplied by the management server to the streaming server in the step E11.

In the step E12, the streaming server obtains the document requested by the user from the content server 11. Finally, in the step E13, the streaming server sends the document to the user terminal 30.

As mentioned above, during transmission of the document to the user terminal, the streaming server sends the current index value of the document to the management server 13 at regular time intervals, for the server to update the index value stored in the user database 14 for the user and the document concerned.

FIG. 2 shows examples of interaction between the user of an IP terminal and a multimedia content during loading into the terminal in streaming mode in the architecture described above with reference to FIG. 1.

In a first example of interaction during a document playback session, the user 40 seeks to resume playback of the document from the beginning of the chapter currently being played. To this end, in the step E21, the user activates a dedicated playback interface command, the effect of which is to generate (E22) a playback request including the corresponding browsing options information.

As mentioned above, if the index value is determined in the user interface from browsing data sent with the current document, this browsing options information includes the playback index value of the beginning of the required chapter. Alternatively, this playback index value is determined by the streaming server 12 after reception of the playback request, by means of a specific request sent to the management server 13.

The playback request is then sent to the streaming server 12 (step E23), which processes it and transmits the current document again, from the beginning of the requested chapter (step E24).

In a second example of interaction, the user 40 wishes to stop playback of a document in progress. To this end, the user activates (step E25) the dedicated command of the playback interface 32. A request to interrupt playback is then generated (step E22) by the playback interface and sent to the streaming server 12 (step E26).

On receiving the interruption request, the streaming server interprets the request and stops (step E27) streaming the data corresponding to the user session identified in the request. The index determination module of the streaming server recovers the index value of the last portion of the document transmitted before the interruption and sends it to the management server 13 (step E28).

In the step E29, the management server closes the user session concerned and then (step E30) updates in the user database 14 index information that corresponds to the user and the document concerned, using the interruption index value received from the streaming server.

FIGS. 3 and 4 show a second embodiment of the invention in which the user terminals are voice access telephone terminals.

Voice access telephone terminals are any telephone terminals enabling voice mode access to a telecommunications network and include residential telephones, public (PSTN) telephones, mobile or cellular (GSM network) telephones, and fixed or mobile IP (Voice over IP (VoIP)) telephones. Generally speaking, such terminals have limited memory capacity and user input/output means that generally consist of a keypad, a loudspeaker and a microphone.

In FIG. 3, the user 40 is using a voice access terminal 50 of this kind connected to the corresponding telecommunication terminal 60. In this embodiment, the digital multimedia document playback system of the invention comprises, in addition to the elements of the document server 10 described above with reference to FIGS. 1 and 2, a voice server 70 accessible in the network 60 and constituting the playback interface of the user terminal.

The playback system includes an adaptation server 80 providing the interconnection between the voice server and the Internet-type network (not shown here) to which the multimedia document server 10 is connected. The function of this adaptation server is to adapt exchanges in accordance with the respective communication protocols used between the voice server 70 in the telephone network 60 and the document server 10 in the Internet-type network concerned.

Thus the adaptation server is substituted for the Internet browser 31 and for the multimedia player 32 shown in FIGS. 1 and 2, in order to format and interpret requests from the management server 13 and the streaming server 12 in a manner that is transparent for those servers. More precisely, the adaptation server 80 comprises an adaptation gateway 801 for interpreting and adapting requests/commands transmitted in the direction from the voice server 70 to the document server 10 and in the opposite direction, and a transcoder 802 for interpreting and converting data streams transmitted between the aforementioned entities 70, 10 to a data format used by the destination entity. For example, the transcoder 802 is capable of converting MP4 (MPEG-Layer-4 Audio) data streamed by the streaming server 12 into the PCM (pulse code modulation) vocal data format accepted by the local server 70.

The operation of this embodiment of the document supply system is described next. The operation of the system with regard to processing requests in the document server 10 is not described in detail here since it is identical to that described with reference to FIGS. 1 and 2.

Concerning the general process of playback of a document, in FIG. 3 a user 40 accesses the document broadcasting service (step E31) by entering the number of the voice server 70 for accessing the document supply service of the invention (for example via a keypad). In response, the user is prompted to authenticate himself, for example by pressing a DTMF key or by voice recognition.

In the step E32, the voice server 70 transfers the authentication request received from the user terminal 50 to the adaptation gateway 801 which reroutes the request (step E33) to the management server 13. In the step E34, the adaptation gateway receives the response validating authentication of the user from the management server. This response contains information on the rights of the authenticated user (list of documents accessible, playback index values, bookmarks, etc.). The adaptation gateway interprets the content of this response and then sends the voice server 70 instructions (step E35) for vocalizing information concerning the user session (list of document titles, browsing data).

In the step E36, the user chooses a document and where applicable a browsing option (vocally or via the keypad of the terminal), the terminal then sending the corresponding playback request to the voice server 70, which in turn forwards the request to the adaptation gateway 801 (step E37), which adapts the playback request and then forwards it to the transcoder 802 (step E40), which in turn forwards it to the streaming server 12 (step E41).

The streaming server 12 recovers the requested document and transfers the corresponding audio stream (based on the IP protocol) to the transcoder 802 (step E42). Finally, the transcoder 802 converts the IP stream into an audio bit stream (e.g. from MP4 to PCM) in real time and forwards it to the adaptation gateway 801 (step E43). In turn, the adaptation gateway forwards the audio bit stream over a synchronous link to the interactive voice server 70 (step E44), which converts it into an audio signal for the user terminal 50.

The user can then interact with the content of the document via his user terminal, as explained below with reference to FIG. 4.

FIG. 4 shows examples of interaction between the user of a voice access terminal and a multimedia content obtained via a voice server in the manner described above.

In a first example of interaction during a document playback session, the user 40 wishes to resume playback of the document from the beginning of the chapter currently being played. To this end, in the step E51, the user presses a key of the keypad or speaks a voice command.

On reception of the command signal from the user, the voice server 70 generates and then transfers to the adaptation gateway 801 (step E52) a playback request including the corresponding browsing options information.

The adaptation gateway 801 then formats the request in the step E53 and transfers the formatted request to the transcoder 802 in the step E54. The transcoder 802 then forwards the request to the streaming server 12 via the Internet-type network. The remainder of the process conforms to the steps E42-E44 described above with reference to FIG. 3.

In a second example of interaction, the user 40 wishes to stop the playback of a current document. To this end, in the step E55, the user activates the dedicated command for stopping playback, for example by pressing a specific key of the keypad of his terminal (DTMF key), by a voice command, or by putting down the handset of his telephone terminal.

On receipt of the control signal activated by the user, the voice server 70 generates a playback interruption request and then transfers it to the adaptation gateway 801 (step E52). The adaptation gateway 801 therefore formats the request in the step E53 and transfers the formatted request to the transcoder 802 in the step E54. The transcoder 802 then sends the request to the streaming server 12 via the Internet-type network. The remainder of the process conforms to the steps E27-E30 described above with reference to FIG. 2.

Note that the present description relates only non-limiting examples of use of the invention. According to other possible variants of the invention, in an IP terminal (FIGS. 1 and 2), the multimedia player 32 can be integrated into the Internet browser 31, for example by means of ActiveX-type mechanisms. Also, the content server 11 can be integrated into the streaming server 12. Similarly, the functions of the management server 13 can be integrated into the streaming server 12. Finally, the functions of the streaming server that are specific to the invention can be transferred to the management server, to enable it to operate with any standard streaming server.

1. A system for supplying digital multimedia documents via a telecommunications network, including document server means (10) adapted to stream digital multimedia documents to user terminals (30) connected to the network (20) and each comprising a playback interface (32) adapted to play digital multimedia documents in real time, wherein the document server means (10) comprises:
a multimedia content server (11) containing digital multimedia documents each associated with a playback index having values that identify predetermined portions of the document;
index determination means (12) for determining at a given time during transmission of any document from the content server to a user terminal, the current playback index value corresponding to the portion of the document being transmitted at that time; and
transmission initiating means (12) for initiating transmission of a document from the content server to a user terminal, starting from a portion of said document identified by a playback index value determined beforehand by said index determination means.

2. The system according to claim 1, wherein the server means further include a user database (14) containing user information for each user including a list of the references of all documents for which the user concerned has playback rights, and for each document reference from said list at least one playback index value corresponding to the portion of the document that was being transmitted at the time of the latest interruption of playback of said document for the user concerned, said transmission initiating means being adapted to initiate transmission of a document from the content server to a user terminal, starting from a portion of said document identified by a playback index value stored in the user database for the user and the document concerned.

3. The system according to claim 2, wherein said server means include means for periodically updating the index value associated with a document from the content server at time intervals during transmission of the document to a user terminal.

4. The system according to claim 1, wherein the playback index associated with a document from the content server includes browsing data describing the organization of the content of said document into a predefined set of sub-portions, the playback interface of each user terminal comprising:
means for processing and presenting to the user said browsing data associated with a given document from the content server; and
means for generating a request to play a document sent to the document server means and including the reference of a document to be played and where appropriate further including browsing options information determined from browsing data associated with the document, said browsing options information indicating a sub-portion of the document chosen by the user of the terminal concerned and from which playback of the document must be initiated.

5. The system according to claim 4, wherein the browsing options information contained in a playback request includes the playback index value of the document, which corresponds to the chosen sub-portion of the document, said index value being determined by the playback interface of the terminal concerned from the browsing data of the document.

6. The system according to claim 4, wherein said index determination means in the document server means are adapted to determine, from said browsing options information contained in a document playback request, the playback index value of the document that corresponds to the chosen sub-portion of the document.

7. The system according to claim 1, wherein said playback index associated with a document from the content server comprises a temporal index that is adapted to measure the transmission time elapsed since the start of a document, a temporal index value consisting of a numerical value expressed in a predefined time unit.

8. The system according to claim 7, wherein certain values of the playback index are associated with tags indicating the beginning of a predefined sub-portion of the document with which the index is associated.

9. The system according to claim 1, wherein a user terminal is an IP-type terminal.

10. The system according to claim 1, wherein a user terminal is a voice access telephone terminal connected to a telephone network, said system further comprising:
a voice server that constitutes the playback interface of the user terminal and is accessible via the telephone network; and
an adaptation server that provides the interconnection between said voice server and an Internet-type network to which said multimedia document server means are connected, for adapting exchanges in accordance with the respective communication protocols used between the voice server in the telephone network and the document server means in the Internet-type network.

11. The system according to claim 1, wherein the documents from the content server are digital audio books and the content of each document is organized into a set of sub-portions of the type defined by the organization characteristic of the content of a paper book.

12. A user terminal connectable to a telecommunications network, wherein the user terminal includes a playback interface adapted to the use of said terminal in a document supply system according to claim 1, said interface comprising:
means for processing and presenting to the user browsing data associated with a given document from the content server; and
means for generating a request to play a document sent to the document server means and including the reference of a document to be played and where appropriate further including browsing options information determined from browsing data associated with the document, said options information indicating a sub-portion of the document chosen by the user of the terminal concerned from which playback of the document must be initiated.

13. A method of playback of a multimedia digital document supplied by a digital multimedia document supply system according to claim 1, comprising the steps of:
selecting a document to play on the user terminal;
obtaining browsing data associated with the selected document;
selecting a sub-portion of the document as a function of said browsing data and generating browsing options information representing the selected sub-portion;
creating a playback request including the reference of the document selected for playback and said browsing options information and sending the request to the document server means via the network; and
receiving and simultaneously playing the selected document starting from the sub-portion of said document determined by the document server means from said browsing options information.
